(19) United States
(12) Patent Application Publication
(10) Pub. No.: US 2014/0317889 A1
(43) Pub. Date: Oct. 30, 2014

(54) STRUCTURE FOR ATTACHING EXTERNALLY MOUNTED MEMBER FOR VEHICLE

(71) Applicant: Kazunori Hida, Wako-shi (JP)

(72) Inventor: Kazunori Hida, Wako-shi (JP)

(73) Assignee: HONDA MOTOR CO., LTD., Tokyo (JP)

(21) Appl. No.: 14/345,267

(22) PCT Filed: Jul. 25, 2012
(86) PCT No.: PCT/JP2012/068816

§ 371 Date: Mar. 17, 2014

(30) Foreign Application Priority Data
Sep. 20, 2011 (JP) 2011-204520

(51) Int. Cl. F16B 21/07; B60R 13/04

(52) U.S. Cl. CPC F16B 21/076; B60R 13/04; B60R 2013/046
USPC 24/293

(57) ABSTRACT

A vehicle body has a through-hole which penetrates a to-be-attached portion in the vehicle width direction. A clip comprises: a securing member including a tubular main body part that is attached to the vehicle body and can be fitted into the through-hole from outside of the vehicle body, and engagement holes penetrating the walls of the main body part; and a slider including a slider main body attached to an externally mounted member and supported by the inner surfaces of the securing member, and slider stop parts formed in the slider main body and having elasticity. The slider stop parts lightly engage the engagement holes at a first position when the slider main body is shallowly inserted into the main body part, and are engaged and held by the main body part at a second position when the slider main body is deeply inserted into the main body part.

### TECHNICAL FIELD

The present invention relates to an attachment structure of a vehicular externally mounted member or exterior member which allows simultaneously painting of a vehicle body and the exterior member.

### BACKGROUND ART

An attachment structure of a vehicular exterior member is disclosed, for example, in Patent Literature 1, including a clip configured to temporarily hold a garnish as the vehicular exterior member so that the garnish and a front bumper of a vehicle can be painted simultaneously.

In the attachment structure disclosed in Patent Literature 1, the garnish is attached to the front bumper via the clip, i.e., attachment clip. The attachment clip is provided to the garnish, and the front bumper has engagement holes formed therein for engagement with the attachment clip. More specifically, the garnish has arms extending toward the front bumper, and the arms each have a temporary fixing prong and a fixing prong formed thereon. The temporary fixing prong is located closer to a distal end of the arm, i.e. far from the garnish, and the fixing prong is located closer to a base portion of the arm, i.e. closer to the garnish.

To attach the garnish to the front bumper, first, the attachment clip of the garnish is positioned so as to mate with the engagement holes of the front bumper. Then, the garnish is pushed toward the front bumper. The arms undergo distortion or flex to thereby allow the temporary fixing prongs formed near the distal ends of the arms to come into engagement with the engagement holes of the front bumper. The garnish is thus engaged with the front bumper with a predetermined space therebetween. In other words, the garnish is temporarily fixed to the front bumper.

The painting work is performed in this temporarily fixed state. Since the garnish is temporarily fixed to the front bumper with the predetermined space therebetween, a paint spraying nozzle can be brought closer to the vicinity of an edge of the front bumper. As a result, it is possible to prevent an occurrence of an unpainted area. After the painting work has been finished, the garnish is pushed in more deeply. The arms undergo distortion or flexing again to thereby allow the temporary fixing prongs to disengage from the engagement holes and the fixing prongs to come into engagement with the engagement holes.

The garnish is supported by the arms while the temporary fixing prongs are engaged with the engagement holes. However, the arms have flexibility so that the prongs can be engaged with and disengaged from the engagement holes. With this attachment clip described above, it is difficult to attach a heavy member such as a side sill garnish to a side sill. Therefore, the side sill garnish and the side sill have to be painted separately, which lowers the production efficiency.

### PRIOR ART LITERATURE

### Patent Literature

Patent Literature 1: Japanese Patent Application Laid-Open Publication No. 2004-352002

### SUMMARY OF INVENTION

### Technical Problem

It is therefore an object of the present invention to provide a vehicular exterior member attachment structure which allows simultaneously painting of a vehicle body and an exterior member even when the exterior member is heavy.

### Solutions to Problem

According to the invention as defined in claim 1, there is provided a vehicular exterior member attachment structure comprising: a vehicle body; an exterior member positioned on an outer surface of the vehicle body; and a clip for attaching the exterior member to the vehicle body, characterized in that: the vehicle body has an attachment portion and a through-hole extending through the attachment portion in a vehicle width direction; the clip comprises a securing member attached to the vehicle body, and a slider attached to the exterior member; the securing member includes a tubular body fitted in the through-hole from outside of the vehicle body, an engagement plate and an engagement prong formed on an outer peripheral surface of the tubular body, and an engagement hole extending through a wall of the tubular body; the engagement plate and the engagement prong are configured to grip the attachment portion from both sides thereof to thereby attach the tubular body to the attachment portion; the slider includes a slider body slidably supported by an inner surface of the securing member with a limited tilting relative to the tubular body, and a locking prong formed on the slider body and having resiliency; and the locking prong is lightly engaged with the engagement hole in a temporarily locked state when the slider body is disposed in a first position where the slider body is shallowly inserted into the tubular body of the securing member, and the locking prong is locked in position against movement relative to the tubular body when the slider body is disposed in a second position where the slider body is deeply inserted into the tubular body.

Preferably, as defined in claim 2, the exterior member is a resin side sill garnish.

Preferably, as defined in claim 3, the engagement hole is located forwardly of the engagement plate in a sliding direction of the slider.

Preferably, as defined in claim 4, the locking prong has a resistance portion formed as a resistance to sliding movement of the slider.

Preferably, as defined in claim 5, the resistance portion is a stepped portion formed on a surface of the locking prong.

### Advantageous Effects of Invention

In the invention as defined in claim 1, the slider body is supported by the inner surface of the securing member with a limited tilting relative to the tubular body. Also, the locking prong is engaged with the engagement hole formed in the tubular body of the securing member in the temporarily locked state where the movement of the locking prong is prevented. In other words, the slider body is positioned at a predetermined position in such a state where the tilting and the movement thereof is regulated by the securing member. With the slider body being positioned in this manner, the exterior member which is supported by the slider body is positioned at a predetermined position. Since the exterior member is thus positioned and prevented from moving, the vehicle body and the exterior member can surely be painted simultaneously in the temporarily locked state even when the exterior member is heavy.

Further, the tubular body of the securing member is fixed to the vehicle body, and the slider body is supported by the securing member with a limited tilting relative to the securing member. Since the tilting of the slider body is thus regulated, the exterior member supported by the slider body can be prevented from tilting or falling.

In the invention as defined in claim 2, the exterior member is a resin side sill garnish. It is possible to paint the vehicle body with the side sill garnish being temporarily fixed to the vehicle body, which improves a degree of freedom of assembly operation, leading to an enhanced productivity and a reduced production cost.

In the invention as defined in claim 3, the engagement hole is located forwardly of the engagement plate in the sliding direction of the slider. Thus, in the attachment operation of the exterior member, the exterior member can be attached to the vehicle body simply by pushing the exterior member toward a distal end of the tubular body. The attachment operation of the exterior member can thus be easily performed.

In the invention as defined in claim 4, the locking prong has the resistance portion formed as a resistance to sliding movement of the slider. Due to this resistance portion, a predetermined force is required for disengaging the locking prong from the engagement hole, which prevents misoperation in the attachment operation such as moving the exterior member to the completely fixed position before painting work.

In the invention as defined in claim 5, the resistance portion is a stepped portion formed on the surface of the locking prong. Thus, by adjusting the shape of the resistance portion, it is possible to easily adjust the force required for disengaging the locking prong from the engagement hole.

### BRIEF DESCRIPTION OF DRAWINGS

FIG. 1 is a perspective view of a vehicle including a side sill garnish attached thereto;

FIG. 2 is an enlarged cross-sectional view taken along line 2-2 of FIG. 1;

FIG. 3 is an enlarged cross-sectional view taken along line 3-3 of FIG. 2;

FIG. 4 is an exploded perspective view showing a vehicle body, a securing member, a slider, and a clip attachment portion according to a first embodiment;

FIG. 5 is an enlarged view of area 5 of FIG. 2;

FIG. 6 is a perspective view of the side sill garnish as viewed from the inner surface side;

FIG. 7 is a view illustrative of the manner in which the slider is attached to the side sill garnish;

FIG. 8 is a view illustrative of the manner in which the securing member is attached to the vehicle body;

FIG. 9 is a view showing an operation of a locking prong shown in FIG. 8;

FIG. 10 is a view of a slider body disposed in a first position and temporarily locked;

FIG. 11 is a cross-sectional view taken along line 11-11 of FIG. 10;

FIG. 12 is a view of the slider body being slid to a second position; and

FIG. 13 is a view showing a locking prong according to a second embodiment.

### DESCRIPTION OF EMBODIMENTS

Certain preferred embodiments of the present invention will be described in detail below with reference to the accompanying drawings.

### Embodiment 1

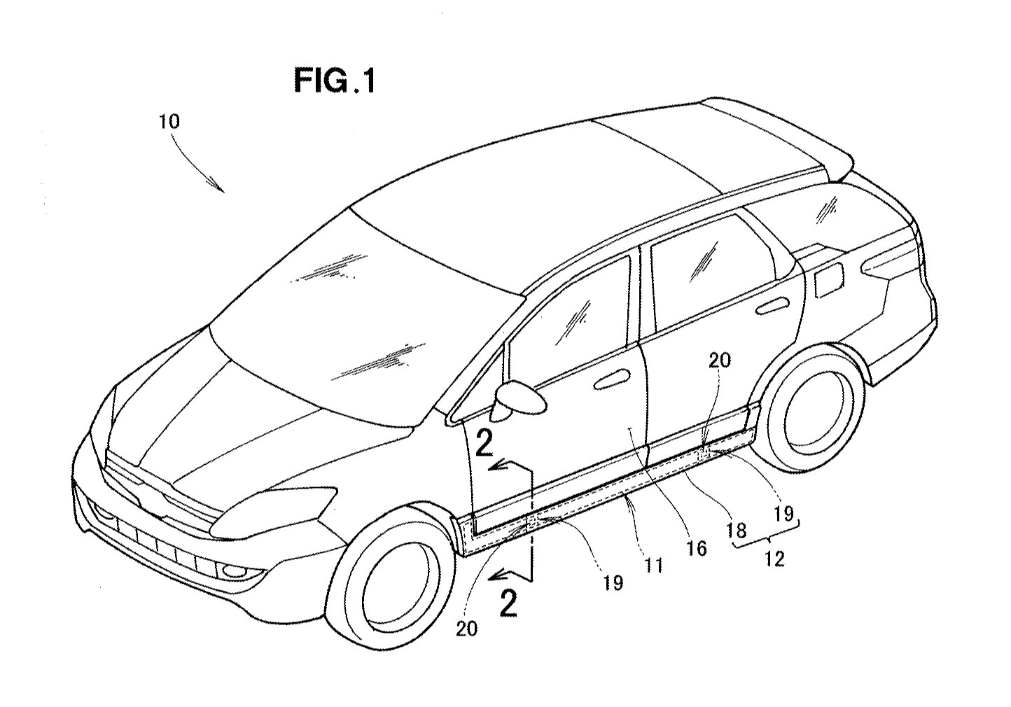

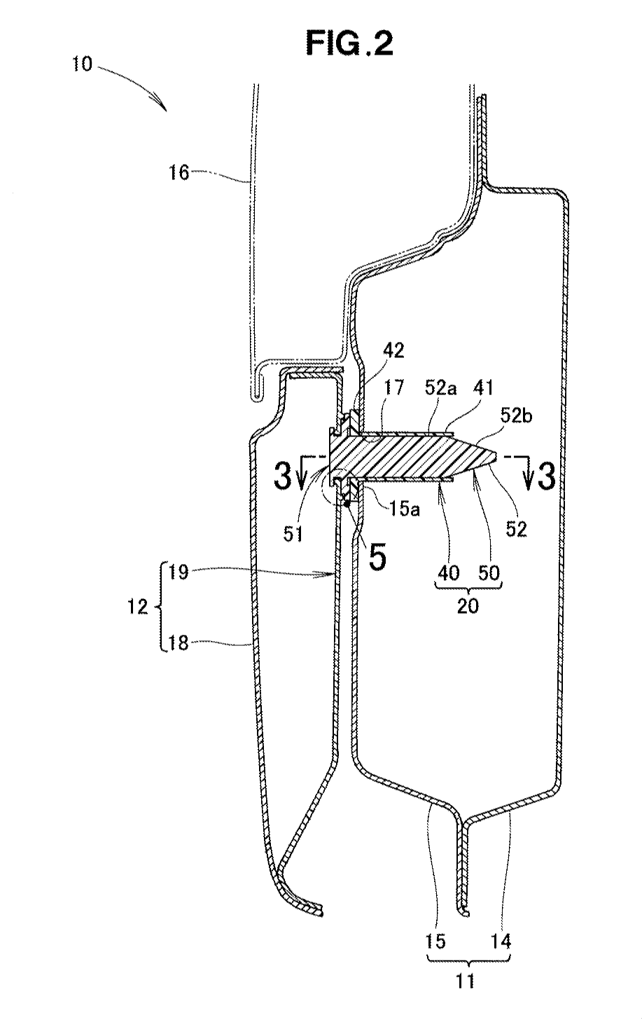

FIGS. 1 to 11 are views showing a vehicular exterior member attachment structure according to a first embodiment.

As shown in FIGS. 1 to 3, a vehicle 10 includes a side sill 11 constituting a part of a vehicle body. A side sill garnish (hereinbelow referred to simply as “garnish”) 12 as an exterior member is attached to the side sill 11 via clips 20. The garnish 12 is a resin member for covering the side sill 11 made of a steel sheet, thereby enhancing the external appearance of the vehicle 10.

The side sill 11 is a hollow member formed by a side sill inner panel 14 located closer to the center in a width direction of the vehicle body, and a side sill outer panel 15 joined to the side sill inner panel 14. The side sill 11 is disposed below a door 16 to extend in a longitudinal direction of the vehicle. The side sill outer panel 15 has through-holes 17 formed in a substantially rectangular shape.

The garnish 12 is attached to the side sill outer panel 15 via the clips 20. The garnish 12 includes a garnish body 18 extending in the longitudinal direction of the vehicle to cover the side sill outer panel 15, and clip attachment parts 19 formed in parts of the garnish body 18 for attachment thereto of the clips 20. Although two clip attachment parts 19 are herein formed in the garnish body 18, more than two clip attachment parts 19 may be formed when the garnish 12 is large.

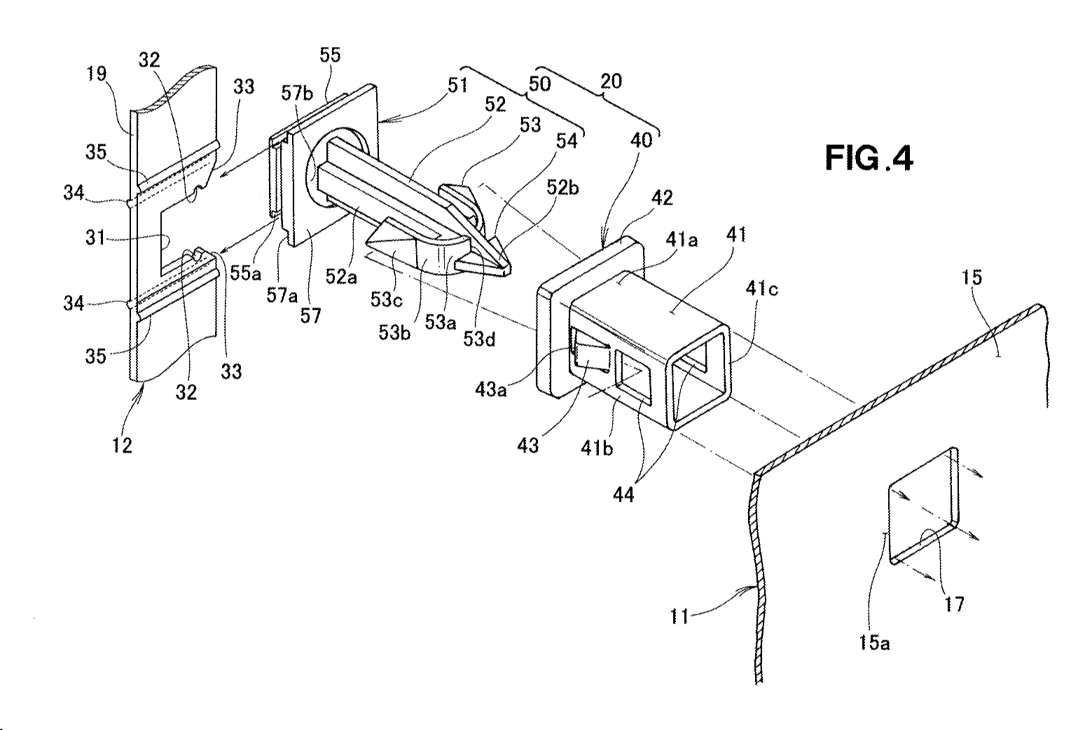

As shown in FIG. 4, each of the clip attachment parts 19 includes a substantially U-shaped opening 31, semicircular stopper sections 32, 32 formed near opening ends of the opening 31, tapered sections 33, 33 formed from the stopper sections 32, 32 to the opening ends so as to increase the diameter or width of the opening 31, a pair of first ridges 34, 34 formed on an outer surface of the clip attachment part 19 at upper and lower sides of the opening 31, a pair of second ridges 35, 35 formed on an inner surface of the clip attachment part 19 at positions slightly outward in a vertical direction of the first ridges 34, 34.

Each of the clips 20 is a resin member including a securing member 40 configured to be attached to the side sill outer panel 15, and a slider 50 to be attached to the garnish 12.

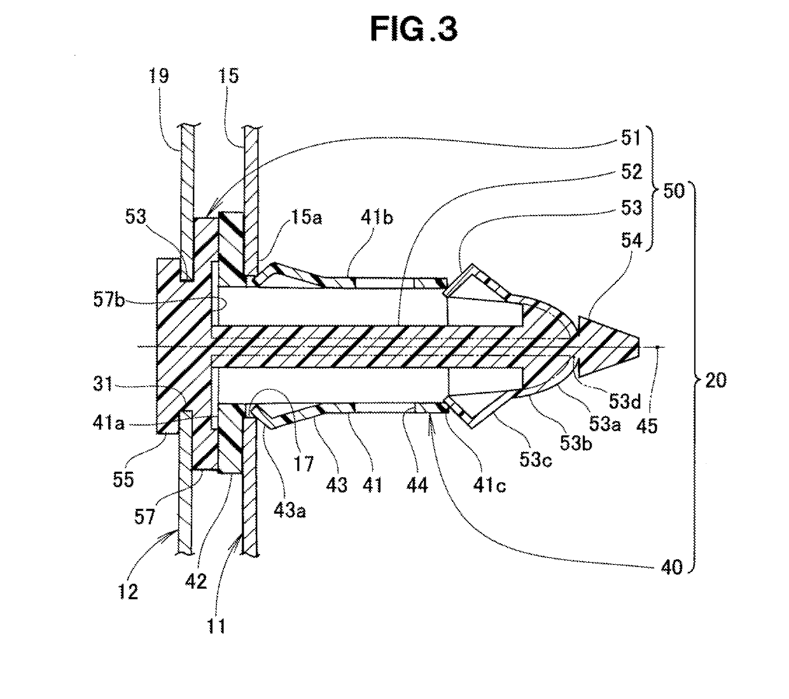

The securing member 40 includes a tubular body 41 having a substantially rectangular cross section (which may have a substantially circular cross section), an engagement plate 42 formed along a whole periphery of a base end 41a of the tubular body 41, a pair of engagement prongs 43 formed on vertical walls 41b of the tubular body 41, and engagement holes 44, 44 extending through the tubular body 41 to be located closer to a distal end 41c of the tubular body 41 than the engagement prongs 43. The engagement prongs 43 are formed to have a substantially V-shaped cross section and to be deflectable toward an axis 45 (FIG. 3) of the tubular body 41.

Each of the engagement prongs 43 and the engagement plate 42 are designed so as to hold the side sill outer panel 15 therebetween, whereby the securing member 40 is fixed to the side sill outer panel 15. Tapered surfaces 43a of the substantially V-shaped engagement prongs 43 come into contact with edges of the through-hole 17 to thereby prevent the movement of the securing member 40 in its axial direction. Namely, the engagement plate 42 and the engagement prong 43 are configured to grip the attachment portion 15a of the side sill outer panel 15 from both sides thereof to thereby attach the tubular body 41 of the securing member 40 to the attachment portion 15a.

The slider 50 includes a slider base 51 configured to be attached to the clip attachment part 19 of the garnish 12, a rod-like slider body 52 having a substantially cross-shaped cross section and extending from the slider base 51 along an inner surface of the tubular body 41 of the securing member 40, a pair of locking prongs 53 formed near a distal end of the slider body 52 for engagement with the securing member 40, and a locking-prong reinforcing portion 54 formed at a distal end of the locking prongs 53 for reinforcing the locking prongs 53.

As shown in FIGS. 3, 4, and 5, the slider base 51 includes a first plate portion 55 formed to be in contact with the surface of the clip attachment part 19 having the first ridge 34 formed thereon, a fitting portion 56 formed to be smaller than the first plate portion 55 so as to be fitted to the opening 31 (FIG. 4) of the clip attachment part 19, and a second plate portion 57 formed to be larger than the fitting portion 56 and to be in contact with the other surface of the clip attachment part 19 having the second ridge 35 formed thereon.

The first plate portion 55 has a notched section 55a at a position corresponding to the first ridge 34. Similarly, the second plate portion 57 has a notched section 57a at a position corresponding to the second ridge 35. Further, the second plate portion 57 has a circular recess 57b on a face opposite to a face in contact with the second ridge 35, and the slider body 52 (FIG. 4) extends from the recess 57b.

The slider body 52 includes a general portion 52a having a substantially rectangular shape, and a tapered portion 52b gradually tapered from a distal end of the general portion 52a. By thus forming the distal end of the slider body 52 in a tapered shape, the slider 50 can be easily inserted into the securing member 40.

Each of the locking prongs 53 includes an arcuate portion 53a extending from the slider body 52 arcuately toward the slider base 51, a linear portion 53b extending linearly from the arcuate portion 53a so as to slightly increase the diameter or width of the locking prong 53, and a locking projection 53c formed at a distal end of the linear portion 53b to have a substantially V-shaped cross section. The arcuate portion 53a, the linear portion 53b, and the locking projection 53c of the locking prong 53 can be integrally deflected with a boundary portion 53d between the locking prong and the slider body 52 as a base point.

The following is a description of how the garnish 12 is attached to the side sill outer panel 15.

First, the clip 20 is assembled as shown in FIG. 4. The slider 50, more specifically, the locking-prong reinforcing portion 54 of the slider 50 is pushed into the securing member 40 from the engagement plate 42 side. While being pushed, the locking prongs 53 are deflected. The slider 50 is further pushed forward with the locking prongs 53 being deflected, until the locking prongs 53 come into engagement with the engagement holes 44 of the securing member 40. The assembly of the clip 20 is thus completed. Then, the clip 20 is attached to the garnish 12.

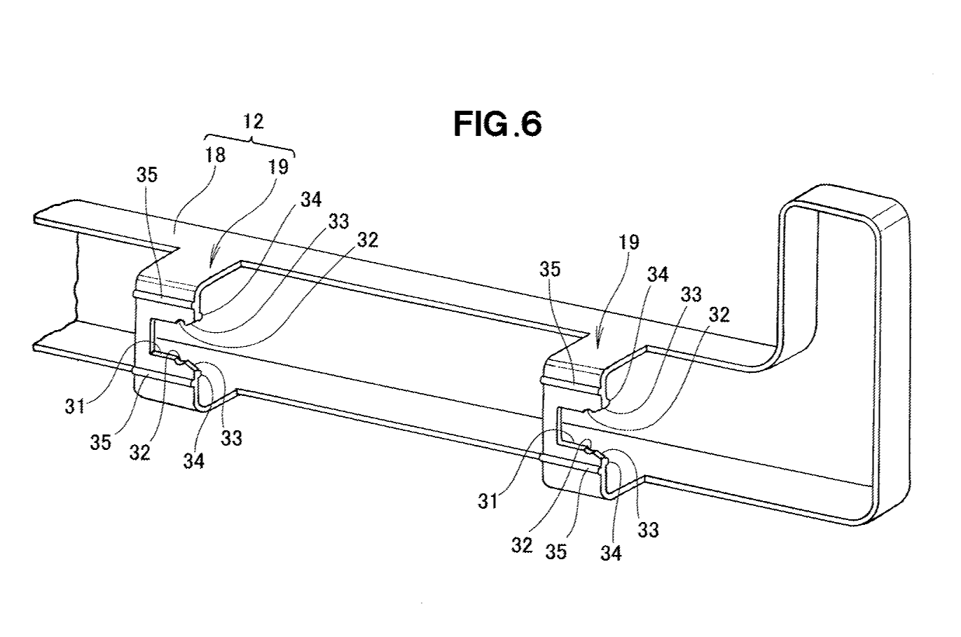

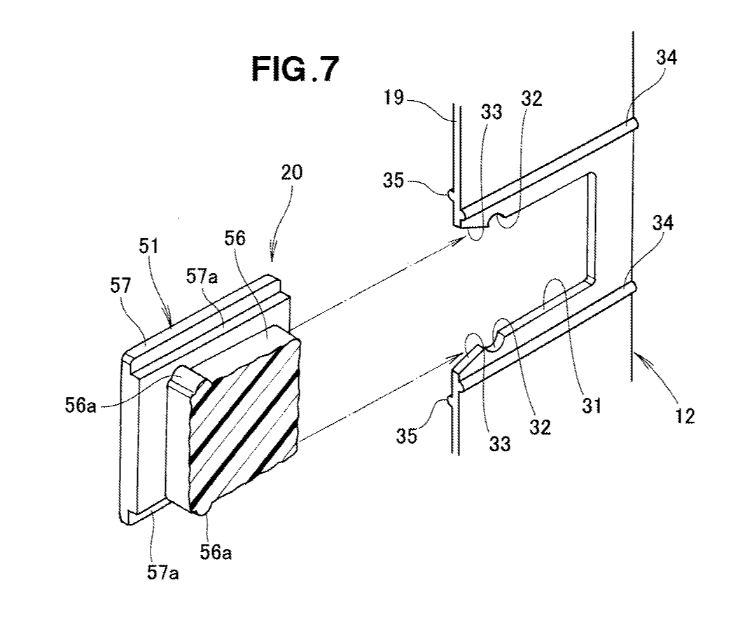

As shown in FIG. 6, the garnish 12 includes the clip attachment parts 19, 19 formed thereon. The clip 20 is attached to each of the clip attachment parts 19, 19 as shown in FIG. 7. More specifically, the fitting portion 56 of the clip 20 is pushed and fitted to the opening 31 of the clip attachment part 19. The fitting portion 56 of the clip 20 has slider-base projections 56a, 56a formed thereon. The opening 31 is formed to have the tapered sections 33, 33 at the opening ends as noted above, so that the tapered sections 33, 33 can be slightly deflected. The fitting portion 56 is pushed into the opening 31 while deflecting the tapered sections 33, 33, whereby the slider-base projections 56a, 56a are brought into engagement with the stopper sections 32, 32. The slider 20 is fixed to the garnish 12 in this manner.

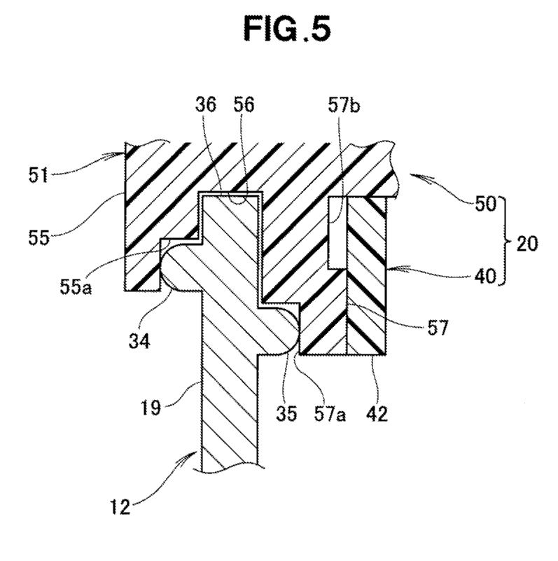

As shown in FIG. 5, the clip attachment part 19 has the first and second ridges 34, 35, and the clip 20 has the notched sections 55a, 57a. The first and second ridges 34, 35 serve as guides at the time when the clip 20 is fitted to the clip attachment part 19, and also as misassembly-preventing parts for enabling sure attachment of the clip 20 in a correct direction.

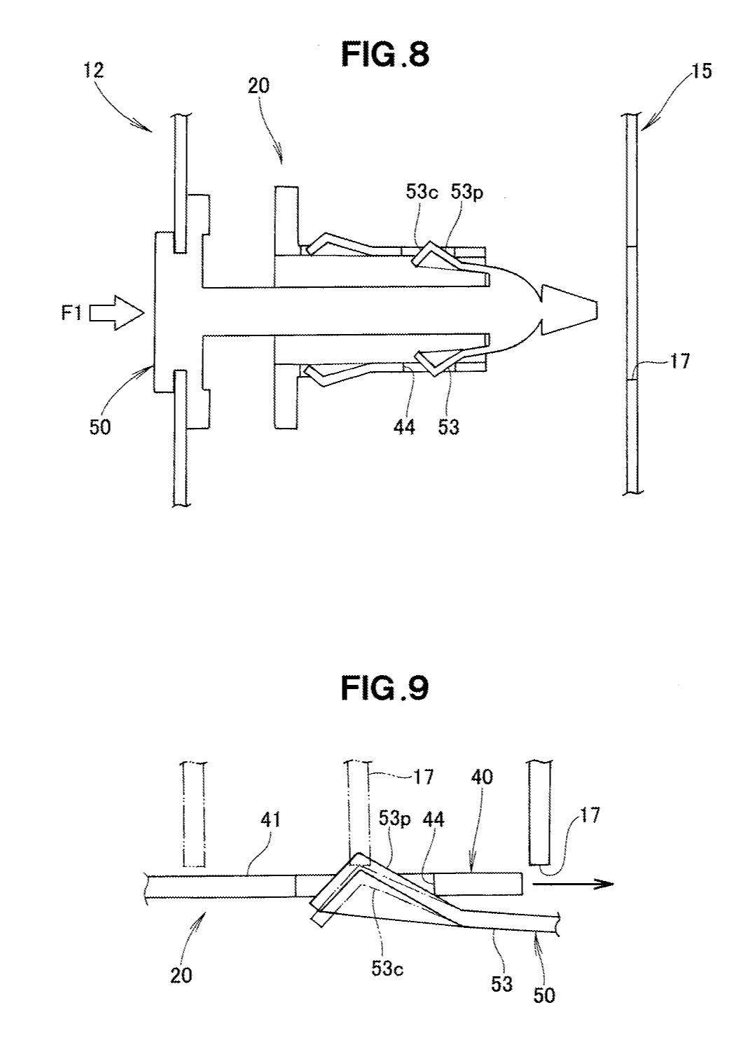

Further, since the first and second ridges 34, 35 have an arcuate cross section, the contact areas between the clip 20 and the clip attachment part 19 can be small, which makes the friction resistance small when the clip 20 is fitted to the clip attachment part 19. Thus, the clip can be smoothly attached to the clip attachment part 19 with small resistance. Next, how the garnish 12 having the clip 20 attached thereto is attached to the side sill outer panel 15 will be explained with reference to FIGS. 8 to 12.

As shown in FIG. 8, the clip 20 attached to the garnish 12 is then attached to the through-hole 17 of the side sill outer panel 15. More specifically, the garnish 12 is brought close to the side sill outer panel 15, and the clip 20 is pushed by a force F1 into the through-hole 17.

As shown in FIG. 9, when the clip 20 is pushed and inserted into the through-hole 17, a tapered face 53p of the locking prong 53 comes into contact with the through-hole 17, and the locking prongs 53 is pushed on the tapered face 53p inwardly of the tubular body 41 (i.e., toward the axis 45 shown in FIG. 3). Since an upper surface of the tapered face 53p is not lowered than an outer surface of the tubular body 41, the locking projection 53c of the locking prong 53 is kept in contact with the engagement hole 44. In other words, the locking projection 53c of the locking prong 53 is caught by the engagement hole 44, so that the slider 50 can be kept from leaving the securing member 40 behind while being pushed in.

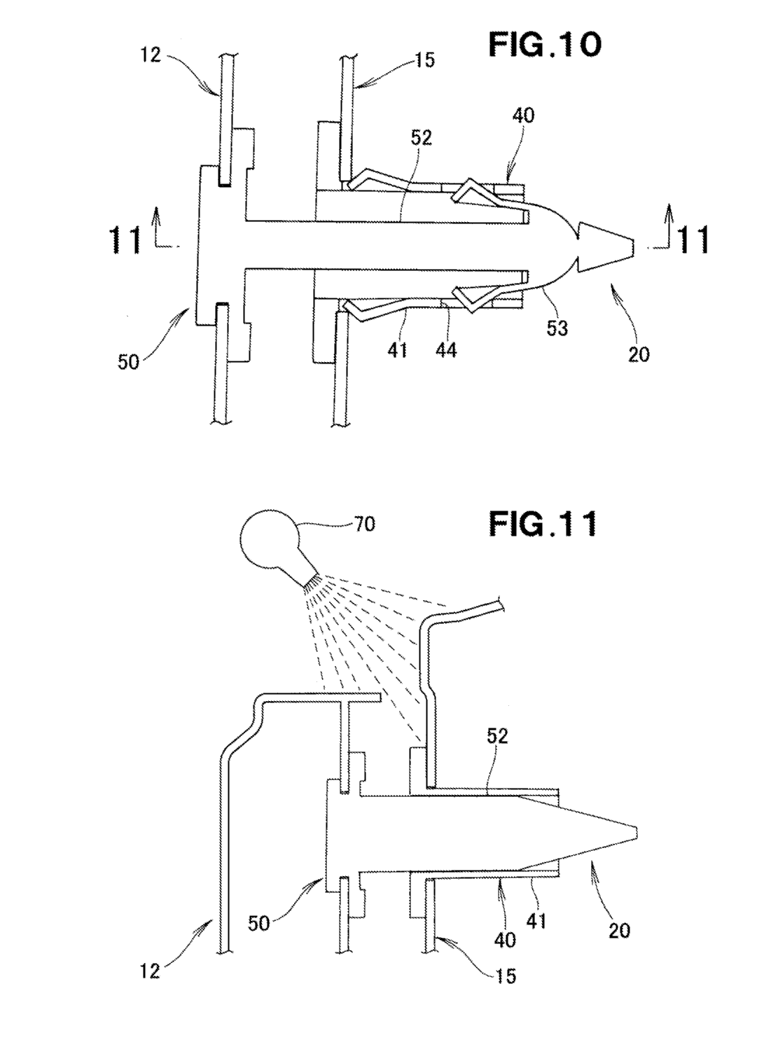

Thus, as shown in FIG. 10, by pushing the garnish 12 toward the through-hole 17, the locking prong 53 is engaged with the engagement hole 44. The locking prong 53 is disposed in a first position where the slider body 52 is shallowly inserted into the tubular body 41 of the securing member 40. In the in the first position, the locking prong 53 is lightly engaged with the engagement hole 44 in a temporarily locked state.

As shown in FIG. 11, the painting work is performed in this state while the slider body is held in the first position. Since an adequate space is secured between the garnish 12 and the side sill outer panel 15, a paint spraying nozzle 70 can be operated freely and desirably. As a result, it is possible to paint simultaneously the garnish 12 and the side sill outer panel 15 with no unpainted area.

The slider body 52 is positioned at a predetermined position in a temporarily fixed state where the tilting and the movement thereof is regulated by the securing member 40 (see also FIG. 10). The slider body 52 which is a rod-like member formed in a substantially cross shape is strong enough to hold a heavy member such as the garnish 12 in the cantilevered temporarily fixed state without being tilted by vibration or pressure generated in the painting work. Thus, the garnish 12 and the side sill outer panel (vehicle body) 15 can be positioned with the predetermined space therebetween to be painted all over including the internal surface of the space.

Further, the tubular body 41 of the securing member 40 is fixed to the side sill outer panel 15, and the slider body 52 is supported by the securing member 40 with a limited tilting relative to the tubular body 41. Since the tilting of the slider body 52 is thus regulated, the garnish 12 supported by the slider body 52 can be prevented from tilting.

Moreover, when the resin side sill garnish is used as the exterior member, it is possible to paint the side sill outer panel 15 with the garnish 12 being temporarily fixed thereto, which improves a degree of freedom of assembly operation, leading to an enhanced productivity and a reduced production cost.

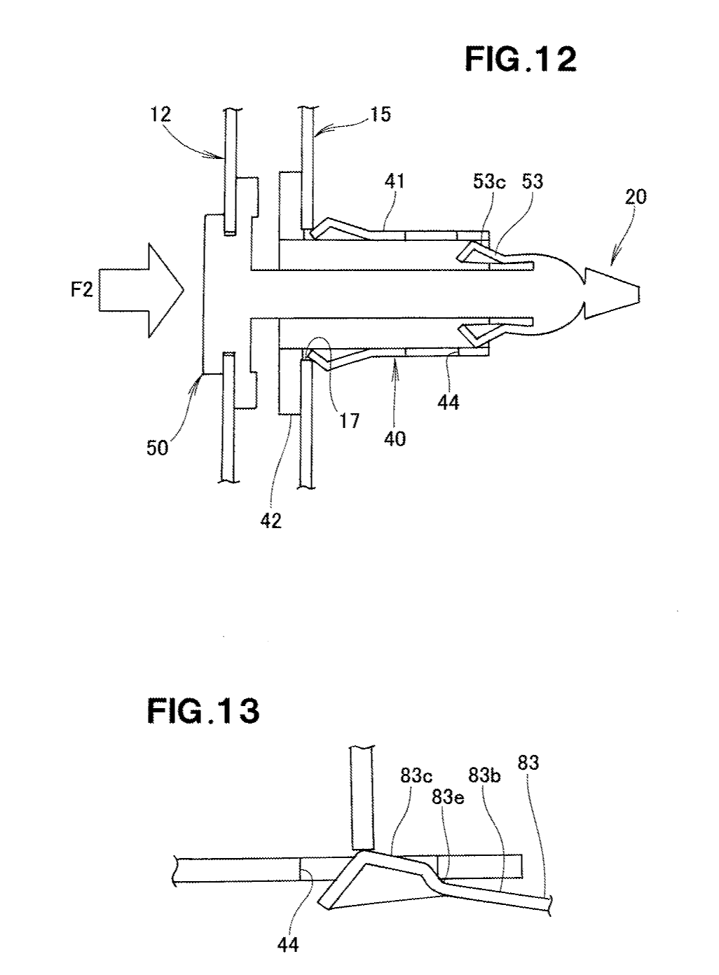

As shown in FIG. 12, when the painting work has been finished, the garnish 12 is further pushed toward the side sill outer panel 15 by a force F2. The locking prongs 53 are deflected, and the slider 50 and the garnish 12 are moved toward the side sill outer panel 15, while the securing member 40 fixed to the through-hole 17 stays at its position. The locking prongs 53 is pushed deeply into the tubular body 41 of the securing member 40 to reach the distal end thereof as shown in FIG. 3, and thus the attachment of the garnish 12 is completed. In FIG. 3, the slider body 52 is disposed in a second position as a completely locked state where the slider body 52 is deeply inserted into the tubular body 41 and completely locked thereto. The locking prongs 53 are locked to the distal end of the tubular body 41.

The engagement holes 44 are located forwardly of the engagement plate 42 in a sliding direction of the slider 50 (left-to-right direction in the figure). Thus, in the attachment operation of the garnish 12, the garnish 12 as a heavy external member can be temporarily held simply by pushing the garnish 12 toward the distal end of the tubular body 41. The attachment operation of the garnish 12 can thus be easily performed.

The force F1 by which the garnish 12 is pushed as shown in FIG. 8 and the force F2 by which the garnish 12 is pushed as shown in FIG. 12 satisfy the following relation: F1<F2. That is, each portion of the slider 50 is configured so that the force F2 greater than the force F1 is required for disengaging the locking prongs 53 from the engagement holes 44. The forces F1 and F2 can be set to predetermined values by adjusting, for example, the spring constant of the locking prongs 53, the friction coefficient of the locking projection 53c, the tilt angle of the locking projection 53c, or a combination thereof.

The force required for disengaging the locking prongs 53 from the engagement holes 44 is set to be greater than a predetermined force (F1). Since the force greater than the predetermined force is required for disengaging the locking prongs 53 from the engagement holes 44, the garnish 12 can be prevented from being erroneously pushed in too deeply. That is, the slider 50 is configured so that the force (F2) required for disengaging the locking prongs 53 from the engagement holes 44 is greater than the force (F1) required for locking the locking prongs 53 to the engagement holes 44.

### Embodiment 2

A second embodiment of the present invention will be described below with reference to FIG. 13. FIG. 13 is a view showing how a garnish of the second embodiment is attached to the side sill outer panel, corresponding to FIG. 9.

As shown in FIG. 13, a locking prong 83 has a stepped portion 83e formed in a stepped shape at a boundary between a linear portion 83b and a locking projection 83c. The stepped portion 83e is a resistance portion formed as a resistance to sliding movement when the locking prong 83 is disengaged from the engagement hole 44.

By providing the stepped portion (resistance portion) 83e, a predetermined force is required for disengaging the locking prong 83 from the engagement hole 44, which prevents misoperation in the attachment operation such as moving the garnish 12 to the completely fixed position before painting work.

Further, since the resistance portion is formed by the stepped portion 83e, it is possible to easily adjust the force required for disengaging the locking prong 83 from the engagement hole 44 by adjusting the shape of the stepped portion 83e.

Whereas the vehicular exterior member attachment structure of the present invention has been explained as a structure for attaching the side sill garnish as a heavy exterior member to the side sill, the invention is not so limited and may also be applied to any members other than the side sill garnish.

### INDUSTRIAL APPLICABILITY

The vehicular exterior member attachment structure of the present invention is particularly suitable for attaching a side sill garnish to a side sill.

### REFERENCE CHARACTERS

10 . . . vehicle, 11 . . . side sill (vehicle body), 12 . . . resin side sill garnish (exterior member), 15a . . . attachment portion, 17 . . . through-hole, 20 . . . clip, 40 . . . securing member 41 . . . tubular body, 41b . . . wall, 42 . . . engagement plate, 43 . . . engagement prong, 44 . . . engagement hole, 50 . . . slider, 52 . . . slider body, 53, 83 . . . locking prong, 83e . . . stepped portion (resistance portion)

1. A vehicular side sill garnish attachment structure comprising: a side sill outer panel; a side sill garnish positioned on an outer surface of the side sill outer panel; and a clip for attaching the side sill garnish to the side sill outer panel, characterized in that:
the side sill outer panel has an attachment portion and a through-hole extending through the attachment portion in a vehicle width direction;
the clip comprises a securing member attached to the side sill outer panel, and a slider attached to the side sill garnish;
the securing member includes a tubular body fitted in the through-hole from outside of the side sill outer panel, an engagement plate and an engagement prong formed on an outer peripheral surface of the tubular body, and an engagement hole extending through a wall of the tubular body;
the engagement plate and the engagement prong are configured to grip the attachment portion from both sides thereof to thereby attach the tubular body to the attachment portion;
the slider includes a slider body slidably supported by an inner surface of the securing member with a limited tilting relative to the tubular body, and a locking prong formed on the slider body and having resiliency;
the locking prong is lightly engaged with the engagement hole in a temporarily locked state when the slider body is disposed in a first position where the slider body is shallowly inserted into the tubular body of the securing member so that the side sill garnish and the side sill outer panel are positioned with an adequate space therebetween for painting work, and the locking prong is locked in position against movement relative to the tubular body when the slider body is disposed in a second position where the slider body is deeply inserted into the tubular body and the side sill garnish and the side sill outer panel are completely fixed;
the side sill garnish is a resin side sill garnish; and
the engagement hole is located forwardly of the engagement plate in a sliding direction of the slider.

2-3. (canceled)

4. The vehicular side sill garnish attachment structure of claim 1, wherein the slider stop part has a resistance portion formed to be resistance to sliding movement of the slider.

5. The vehicular side sill garnish attachment structure of claim 4, wherein the resistance portion is a stepped portion formed on a surface of the slider stop part.

6. The vehicular side sill garnish attachment structure of claim 1, wherein the side sill garnish is pushed to the side sill outer panel by a first force, and, after having been painted, pushed further to the side sill outer panel by a second force greater than the first force.

7. The vehicular side sill garnish attachment structure of claim 1, wherein the slider body is a rod-like member formed in a substantially cross shape.
